(19) United States
(12) Patent Application Publication
(10) Pub. No.: US 2025/0226883 A1
(43) Pub. Date: Jul. 10, 2025

(54) Electronic Device with Reciprocal Electro-Optical Transceiver

(71) Applicant: Apple Inc., Cupertino, CA (US)

(72) Inventors: Ramin Khayatzadeh, Munich (DE); Bernhard Raaf, Neuried (DE); Josef Hausner, Germering (DE)

(21) Appl. No.: 19/012,645

(22) Filed: Jan. 7, 2025

Related U.S. Application Data
(60) Provisional application No. 63/619,223, filed on Jan. 9, 2024.

(51) Int. Cl. H04B 10/112

(52) U.S. Cl. CPC H04B 10/112; H04B 2210/006

(57) ABSTRACT

An electronic device may include wireless circuitry with light sources that emit optical local oscillator (LO) signals onto optical paths coupled to a photomixer of an antenna. An electro-optical modulator (EOM) on an optical path may modulate one of the LO signals using an intermediate frequency signal and single sideband carrier suppression. The antenna may transmit and receive radio-frequency signals at the same frequency without adjustment to the LO signals. The frequency of the radio-frequency signals is equal to an offset between LO signals plus the frequency of the intermediate frequency signal. This may allow the device to switch between transmission and reception and/or frequencies of the radio-frequency signal without adjusting the optical LO signals, which prevents needing to re-lock the phases of the light sources and optimizes wireless performance.

This application claims the benefit of U.S. Provisional Patent Application No. 63/619,223, filed Jan. 9, 2024, which is hereby incorporated by reference herein in its entirety.

### FIELD

This disclosure relates generally to electronic devices, including electronic devices with wireless circuitry.

### BACKGROUND

Electronic devices can be provided with wireless capabilities. An electronic device with wireless capabilities has wireless circuitry that includes one or more antennas. The wireless circuitry is used to perform communications using radio-frequency signals conveyed by the antennas.

As software applications on electronic devices become more data-intensive over time, demand has grown for electronic devices that support wireless communications at higher data rates. However, the maximum data rate supported by electronic devices is limited by the frequency of the radio-frequency signals. As communication frequencies increase, it can become difficult to reconfigure the wireless circuitry to convey signals at different frequencies and to switch between signal transmission and reception while still exhibiting sufficient levels of wireless performance.

### SUMMARY

An electronic device may include wireless circuitry. The wireless circuitry may include an antenna element (e.g., a radiator), a first light source, a second light source, and an optical signal path that couples the light sources to the antenna. The light sources may emit optical local oscillator (LO) signals onto the optical signal path. The optical LO signals are separated by a frequency offset. The antenna element may be operably coupled to a photomixer. An electro-optical modulator (EOM) may be disposed on the optical signal path. A transmit chain may be coupled to an electrode of the EOM. A receive chain may be coupled to an electrical terminal of the photomixer.

The wireless circuitry may transmit and receive radio-frequency signals using the antenna to minimize device volume. The transmit chain may transmit an intermediate frequency signal at an intermediate frequency to an electrode of the EOM. The EOM may modulate the second optical LO signal based on the intermediate frequency signal and using a single sideband carrier suppression scheme. The modulation may include wireless data during transmission and may be free from wireless data during reception of the radio-frequency signals. The optical signal path may illuminate the photomixer using the optical LO signals. The photomixer may transmit the radio-frequency signals and may receive the radio-frequency signals using the optical LO signals. The radio-frequency signals may be at a frequency equal to the frequency offset plus the intermediate frequency. The photomixer may convert received radio-frequency signals into receive frequency signals at the intermediate frequency. A receive chain may decode wireless data from the receive signals. If desired, the wireless circuitry may tune the frequency of the radio-frequency signals by controlling the transmit chain to tune the intermediate frequency signal provided to the EOM. Alternatively, a full duplex scheme may be used.

Modulating second optical LO using an intermediate frequency signal and using single sideband carrier suppression in this way may allow the wireless circuitry to transmit and receive the radio-frequency signals at the same frequency without adjustment to the optical LO signals. Switching between transmission and reception and/or radio frequencies without adjusting the optical LO signals may allow the wireless circuitry to convey the radio-frequency signals with minimal phase noise and without requiring the light sources to be frequently re-locked, which minimizes delay and disruption in performing wireless communications.

An aspect of the disclosure provides wireless circuitry. The wireless circuitry can include an antenna element coupled to a photomixer. The wireless circuitry can include an optical signal path configured to illuminate the photomixer using a first optical local oscillator (LO) signal at a first frequency and a second optical LO signal at a second frequency that is different from the first frequency, the antenna element being configured to convey a first radio-frequency signal at a third frequency based on the first optical LO signal and the second optical LO signal. The wireless circuitry can include an electro-optical modulator (EOM) disposed on the optical signal path, the EOM being configured to modulate the second optical LO signal using a second radio-frequency signal at a fourth frequency that is lower than the third frequency.

An aspect of the disclosure provides a method of operating wireless circuitry. The method can include emitting, using a first light source, a first optical local oscillator (LO) signal at a first frequency onto a first optical path. The method can include emitting, using a second light source, a second optical LO signal at a second frequency different from the first frequency onto a second optical path. The method can include modulating, using an electro-optical modulator (EOM) disposed on the second optical path, wireless data onto a first sideband of the second optical LO signal while suppressing a second sideband of the second optical LO signal. The method can include illuminating a photomixer using the first optical LO signal and the first sideband of the second optical LO signal. The method can include generating, using the photomixer, a first current on a radiator based on the first optical LO signal and the first sideband of the second optical LO signal. The method can include transmitting, using the radiator, a first radio-frequency signal associated with the first current.

An aspect of the disclosure provides an electronic device. The electronic device can include a photomixer. The electronic device can include a radiator coupled to the photomixer. The electronic device can include a first light source configured to generate a first optical local oscillator (LO) signal at a first frequency. The electronic device can include a second light source configured to generate a second optical LO signal at a second frequency different from the first frequency. The electronic device can include an optical signal path coupled to the first light source and the second light source and configured to illuminate the photomixer using the first optical LO signal and the second optical LO signal. an electro-optical modulator (EOM) disposed on the optical signal path, wherein the EOM is configured to suppress a single sideband of the second optical LO signal, and the photomixer is configured to transmit, using the radiator, a radio-frequency signal based on the first optical LO signal and the second optical LO signal.

### BRIEF DESCRIPTION OF THE DRAWINGS

FIG. 1 is a block diagram of an illustrative electronic device having wireless circuitry in accordance with some embodiments.

FIG. 2 is a top view of illustrative wireless circuitry that transmits wireless signals at frequencies greater than about 100 GHz based on optical local oscillator (LO) signals in accordance with some embodiments.

FIG. 3 is a top view showing how illustrative wireless circuitry of the type shown in FIG. 2 may convert received wireless signals at frequencies greater than about 100 GHz into intermediate frequency signals based on optical LO signals in accordance with some embodiments.

FIG. 4 is a top view showing how wireless circuitry of the type shown in FIGS. 2 and 3 may be stacked to cover multiple polarizations in accordance with some embodiments.

FIG. 5 is a top view showing how wireless circuitry of the type shown in FIG. 4 may be integrated into a phased antenna array for conveying wireless signals at frequencies greater than about 100 GHz within a corresponding signal beam.

FIG. 6 is a circuit diagram of illustrative wireless circuitry that is switchable between transmit and receive modes in which the wireless circuitry conveys wireless signals at the same frequency without adjustment to optical LO signals in accordance with some embodiments.

FIG. 7 is a state diagram showing how illustrative wireless circuitry of the type shown in FIG. 6 may be operated in transmit and receive modes without adjustment to optical LO signals in accordance with some embodiments.

FIG. 8 is a flow chart of illustrative operations involved in transmitting wireless signals using wireless circuitry in a transmit mode in accordance with some embodiments.

FIG. 9 is a flow chart of illustrative operations involved in receiving wireless signals using wireless circuitry in a receive mode in accordance with some embodiments.

FIG. 10 is a circuit diagram of illustrative wireless circuitry that transmits and receives wireless signals at the same frequency using a full duplex scheme in accordance with some embodiments.

### DETAILED DESCRIPTION

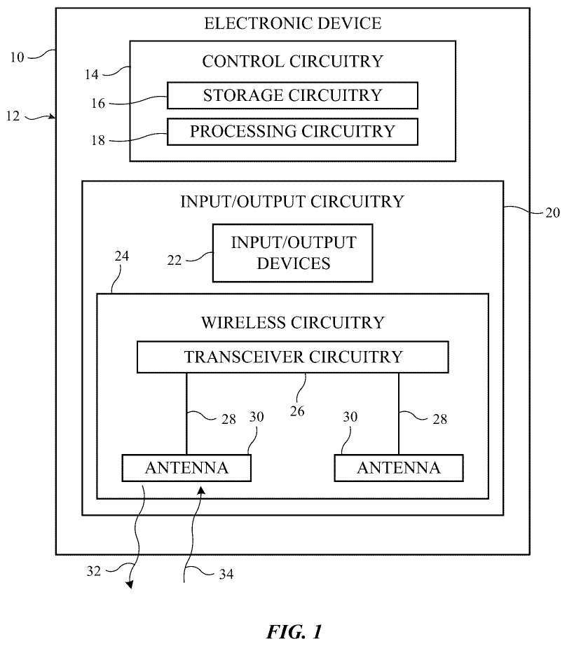

Electronic device 10 of FIG. 1 (sometimes referred to herein as electro-optical device 10) may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas 30 (e.g., antenna elements). Wireless circuitry 24 may also include transceiver circuitry 26. Transceiver circuitry 26 may include transmitter circuitry, receiver circuitry, modulator circuitry, photomixers, demodulator circuitry (e.g., one or more modems), radio-frequency circuitry, one or more radios, intermediate frequency circuitry, optical transmitter circuitry, optical receiver circuitry, optical light sources, other optical components, baseband circuitry (e.g., one or more baseband processors), amplifier circuitry, clocking circuitry such as one or more local oscillators and/or phase-locked loops, memory, one or more registers, filter circuitry, switching circuitry, analog-to-digital converter (ADC) circuitry, digital-to-analog converter (DAC) circuitry, radio-frequency transmission lines, optical fibers, and/or any other circuitry for transmitting and/or receiving wireless signals using antennas 30. The components of transceiver circuitry 26 may be implemented on one integrated circuit, chip, system-on-chip (SOC), die, printed circuit board, substrate, or package, or the components of transceiver circuitry 26 may be distributed across two or more integrated circuits, chips, SOCs, printed circuit boards, substrates, and/or packages.

The example of FIG. 1 is illustrative and non-limiting. While control circuitry 14 is shown separately from wireless circuitry 24 in the example of FIG. 1 for the sake of clarity, wireless circuitry 24 may include processing circuitry (e.g., one or more processors) that forms a part of processing circuitry 18 and/or storage circuitry that forms a part of storage circuitry 16 of control circuitry 14 (e.g., portions of control circuitry 14 may be implemented on wireless circuitry 24). As an example, control circuitry 14 may include baseband circuitry (e.g., one or more baseband processors), digital control circuitry, analog control circuitry, and/or other control circuitry that forms part of wireless circuitry 24. The baseband circuitry may, for example, access a communication protocol stack on control circuitry 14 (e.g., storage circuitry 20) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Transceiver circuitry 26 may be coupled to each antenna 30 in wireless circuitry 24 over a respective signal path 28. Each signal path 28 may include one or more radio-frequency transmission lines, waveguides, optical fibers, optical waveguides, and/or any other desired lines/paths for conveying wireless signals between transceiver circuitry 26 and antenna 30. Antennas 30 may be formed using any desired antenna structures for conveying wireless signals. For example, antennas 30 (e.g., antenna elements) may include resonating elements (radiators) that are formed from dipole antenna structures, planar dipole antenna structures (e.g., bowtie antenna structures), slot antenna structures, loop antenna structures, patch antenna structures, inverted-F antenna structures, planar inverted-F antenna structures, helical antenna structures, monopole antennas, dipoles, hybrids of these designs, or any other antenna types. Filter circuitry, switching circuitry, impedance matching circuitry, and/or other antenna tuning components may be adjusted to adjust the frequency response and wireless performance of antennas 30 over time.

If desired, two or more of antennas 30 may be integrated into a phased antenna array (sometimes referred to herein as a phased array antenna) in which each of the antennas conveys wireless signals with a respective phase and magnitude that is adjusted over time so the wireless signals constructively and destructively interfere to produce (form) a signal beam in a given pointing direction. The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of currents on an antenna resonating (radiating) element in the antenna by signals within the frequency band(s) of operation of the antenna.

Transceiver circuitry 26 may use antenna(s) 30 to transmit and/or receive wireless signals that convey wireless communications data between device 10 and external wireless communications equipment (e.g., one or more other devices such as device 10, a wireless access point or base station, etc.). The wireless communications data may be conveyed bidirectionally or unidirectionally. The wireless communications data may, for example, include data that has been encoded into corresponding data symbols, packets, datagrams, and/or frames such as wireless data associated with a telephone call, streaming media content, internet browsing, wireless data associated with software applications running on device 10, email messages, etc.

Additionally or alternatively, wireless circuitry 24 may use antenna(s) 30 to perform wireless sensing operations. The sensing operations may allow device 10 to detect (e.g., sense or identify) the presence, location, orientation, and/or velocity (motion) of objects external to device 10 (e.g., using a radar scheme or another spatial ranging scheme). Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc.

Wireless circuitry 24 may transmit and/or receive wireless signals within corresponding frequency bands of the electromagnetic spectrum (sometimes referred to herein as communications bands or simply as “bands”). The frequency bands handled by communications circuitry 26 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHZ, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands (e.g., between 10-300 GHZ), near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 300 GHz). However, the data rates supported by centimeter and millimeter wave signals may still be insufficient to meet all the data transfer needs of device 10. To support even higher data rates such as data rates up to 5-10 Gbps or higher, wireless circuitry 24 may convey wireless signals at frequencies greater than 100 GHz.

As shown in FIG. 1, wireless circuitry 24 may transmit wireless signals 32 and may receive wireless signals 34 at frequencies greater than around 100 GHz (sometimes also referred to as tremendously high frequency (THF) frequencies). Wireless signals 32 and 34 may sometimes be referred to herein as THF signals 32 and 34, sub-THz signals 32 and 34, THz signals 32 and 34, or sub-millimeter wave signals 32 and 34. THF signals 32 and 34 may be at sub-THz or THz frequencies such as frequencies between 100 GHz and 1 THz, between 100 GHz and 10 THz, between 100 GHz and 2 THz, between 200 GHz and 1 THz, between 300 GHZ and 1 THz, between 300 GHz and 2 THz, between 300 GHz and 10 THz, between 100 GHz and 800 GHz, between 200 GHz and 1.5 THz, etc. (e.g., within a sub-THz, THz, THF, or sub-millimeter frequency band such as a 6G frequency band).

The high data rates supported by these frequencies may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate connection between a display driver on device 10 and a display that displays ultra-high resolution video), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

Wireless circuitry 24 may include one or more antennas 30 that convey THF signals (e.g., at frequencies greater than around 100 GHz) and/or may include one or more antennas 30 that convey non-THF signals (e.g., at frequencies less than around 100 GHZ). Transceiver circuitry 26 may include clocking circuitry that generates one or more clock signals (e.g., local oscillator signals). Transceiver 26 may use the clock signals to transmit and/or receive signals (e.g., THF signals and/or non-THF signals).

The clock signals may, for example, be provided as an input to one or more mixers in transceiver circuitry 26 for converting signals between different frequencies (e.g., between baseband frequencies, intermediate frequencies, radio frequencies, optical frequencies, etc.). The mixers may include one or more radio mixers (e.g., for converting between radio, intermediate, and/or baseband frequencies) and/or one or more electro-optical (EO) mixers (e.g., for converting between radio frequencies and optical frequencies or between optical frequencies). The EO mixers may sometimes be referred to herein as photomixers and may include photodiodes (e.g., uni-travelling-carrier photodiodes (UTC PD)), electrooptical modulators (e.g., Mach-Zehnder modulators), and/or other mixers that convert signals from radio frequencies to optical frequencies and/or from optical frequencies to radio frequencies. Transceiver circuitry 26 may use radio mixers to convey non-THF signals whereas one or both of radio mixers and EO mixers may be used to convey THF signals, for example. If desired, the clocking circuitry in transceiver circuitry 26 may include one or more phase locked loops (PLLs), frequency locked loops (FLLs), self-injection locking (SIL) loops, and/or other circuitry that serves to process the clock signals generated by the clocking circuitry (e.g., to phase-lock the clock signals, to frequency-lock the clock signals, to self-injection lock the clock signals, etc.).

Implementations in which wireless circuitry 24 conveys THF signals using electro-optical circuitry are described herein as an example. However, in general, wireless circuitry 24 may convey non-THF signals in addition to or instead of THF signals. In implementations where wireless circuitry 24 conveys THF signals, different antennas 30 may be used to transmit THF signals 32 than are used to receive THF signals 34. However, space is at a premium within electronic devices such as device 10. Handling transmission of THF signals 32 and reception of THF signals 34 using different antennas 30 can consume an excessive amount of space and other resources within device 10 because two antennas 30 and signal paths 28 would be required to handle both transmission and reception. To minimize space and resource consumption within device 10, the same antenna 30 and signal path 28 may be used to both transmit THF signals 32 and to receive THF signals 34. If desired, multiple antennas 30 in wireless circuitry 24 may transmit THF signals 32 and may receive THF signals 34. The antennas may, if desired, be integrated into a phased antenna array that transmits THF signals 32 and that receives THF signals 34 within a corresponding signal beam oriented in a selected beam pointing direction.

It can be challenging to incorporate components into wireless circuitry 24 that support communications at these high frequencies. If desired, transceiver circuitry 26 and signal paths 28 may include optical components that convey optical signals to support the transmission of THF signals 32 and the reception of THF signals 34 in a space and resource-efficient manner. The optical signals may be used in transmitting THF signals 32 at THF frequencies and in receiving THF signals 34 at THF frequencies.

FIG. 2 is a diagram of illustrative wireless circuitry 35 that may be configured to transmit THF signals 32 and/or receive THF signals 34 using optical signals (e.g., for a corresponding antenna 30 of FIG. 1). Wireless circuitry 35 may include one or more antenna radiating (resonating) elements such as radio-frequency radiators 36. Radiators 36 are sometimes also referred to herein as resonating elements 36, radiating elements 36, resonating element arms 36, radiating element arms 36, resonators 36, or antenna elements 36. In the example of FIG. 2, wireless circuitry 35 includes two radiators 36. This is illustrative and non-limiting. Wireless circuitry 35 need not have two radiators 36 and may, if desired, include a single radiator 36 or more than two radiators 36.

Implementations in which radiators 36 include radiating arms (sometimes also referred to herein as antenna resonating element arms, radiating element arms, or antenna arms) are described herein as an example. In FIGS. 2-5, for example, wireless circuitry 35 is illustrated as including a planar dipole antenna (sometimes referred to as a “bowtie” antenna) having two opposing radiators 36 (e.g., bowtie arms or dipole arms) coupled to an intervening photomixer. This is illustrative and non-limiting. The radiating arms may, if desired, include monopole arms, inverted-F antenna arms, helical arms, or other types of radiating arms. More generally, radiators 36 may include radio-frequency radiating or resonating arms, patches, slots (e.g., in a conductive ground plane), waveguides, dielectric resonating elements, loops, or any other desired antenna radiators implemented using any desired antenna resonating element architecture that conveys radio-frequency signals based on radio-frequency antenna currents flowing around the perimeter of the radiators. While referred to herein as radiators for the sake of simplicity, radiators 36 need not radiate (transmit) radio-frequency signals and may, if desired, only receive radio-frequency signals.

As shown in FIG. 2, wireless circuitry 35 may include a programmable heterodyne photomixer such as photomixer 42 (sometimes also referred to herein as heterodyne photomixer 42) coupled to and/or between radiators 36. A given antenna 30 that conveys THF signals in device 10 (FIG. 1) may include some or all of wireless circuitry 35 (e.g., a given antenna 30 may include the radiator(s) 36 of wireless circuitry 35 but not the photomixer 42 of wireless circuitry 35 or may include both the radiator(s) 36 and the photomixer 42 of wireless circuitry 35). Photomixer 42 may be a programmable photodiode (PD), as one example. Implementations in which photomixer 42 is a programmable uni-travelling-carrier photodiode (UTC PD) are sometimes described herein as an example. Photomixer 42 may therefore sometimes be referred to herein as photodiode 42, UTC PD 42, or programmable UTC PD 42. This is illustrative and non-limiting.

In general, photomixer 42 may include any desired type of heterodyne-based adjustable/programmable photodiode or photomixer that converts electromagnetic energy (e.g., light or light energy) at two different optical frequencies (e.g., infrared, visible, and/or ultraviolet frequencies) to electrical current at a THF frequency on radiators 36 and/or vice versa (e.g., where the THF frequency is given by the difference between the two different optical frequencies). Each radiator 36 may, for example, have a first edge at or coupled to photomixer 42 and a second edge opposite the first edge that is wider than the first edge (e.g., in implementations where radiators 36 form at least part of a bowtie antenna). Other radiating elements or arms may be used if desired.

Photomixer 42 may have a bias terminal 38 that receives one or more control signals V_{BIAS}. Control signals V_{BIAS} may include bias voltages provided at one or more voltage levels and/or other control signals for controlling the operation of photomixer 42 such as impedance adjustment control signals for adjusting the output impedance of photomixer 42. Control circuitry 14 (FIG. 1) may provide (e.g., apply, supply, assert, etc.) control signals V_{BIAS} at different settings (e.g., values, magnitudes, etc.) to dynamically control (e.g., program or adjust) the operation of photomixer 42 over time.

For example, control signals V_{BIAS} may be used to control whether wireless circuitry 35 transmits THF signals 32 or receives THF signals 34. When control signals V_{BIAS} include a bias voltage asserted at a first level or magnitude, wireless circuitry 35 may be configured to transmit THF signals 32. When control signals V_{BIAS} include a bias voltage asserted at a second level or magnitude, wireless circuitry 35 may be configured to receive THF signals 34. In some implementations that are described herein as an example, the second level or magnitude is zero volts (e.g., the bias voltage may be de-asserted, decoupled, or switched off to configure photomixer 42 to receive THF signals 34) or another level or magnitude less than the first level or magnitude. In the example of FIG. 2, control signals V_{BIAS} include the bias voltage asserted at the first level to configure wireless circuitry 35 to transmit THF signals 32. If desired, control signals V_{BIAS} may also be adjusted to control the waveform of the THF signals (e.g., as a squaring function that preserves the modulation of incident optical signals, a linear function, etc.), to perform gain control on the signals conveyed by wireless circuitry 35, and/or to adjust the output impedance of photomixer 42.

As shown in FIG. 2, photomixer 42 may be optically coupled to optical path 40. Optical path 40 may include one or more optical fibers or waveguides. Photomixer 42 may receive optical signals from transceiver circuitry 26 (FIG. 1) over optical path 40. The optical signals may include a first optical local oscillator (LO) signal LO1 and a second optical local oscillator signal LO2. Optical local oscillator signals LO1 and LO2 may be generated by light sources in transceiver circuitry 26 (FIG. 1).

Optical local oscillator signals LO1 and LO2 may be at optical wavelengths (e.g., between 400 nm and 700 nm), ultra-violet wavelengths (e.g., near-ultra-violet or extreme ultraviolet wavelengths), and/or infrared wavelengths (e.g., near-infrared wavelengths, mid-infrared wavelengths, or far-infrared wavelengths). Optical local oscillator signal LO2 may be offset in wavelength from optical local oscillator signal LO1 by a wavelength offset X. Wavelength offset X may be equal to the wavelength of the THF signals conveyed by wireless circuitry 35 (e.g., between 100 GHz and 1 THz, between 100 GHz and 2 THz, between 300 GHZ and 800 GHz, between 300 GHz and 1 THz, between 300 and 400 GHz, etc.).

During signal transmission, wireless data (e.g., wireless data packets, symbols, frames, etc.) may be modulated onto optical local oscillator signal LO2 to produce modulated optical local oscillator signal LO2′. If desired, optical local oscillator signal LO1 may be provided with an optical phase shift S. Optical path 40 may illuminate photomixer 42 with optical local oscillator signal LO1 (plus the optical phase shift S when applied) and modulated optical local oscillator signal LO2′. If desired, lenses or other optical components (not shown) may be interposed between optical path 40 and photomixer 42 to help focus the optical local oscillator signals onto photomixer 42.

Photomixer 42 may convert optical local oscillator signal LO1 and modulated local oscillator signal LO2′ (e.g., beats between the two optical local oscillator signals) into radio-frequency currents (e.g., antenna currents) that run along the perimeter of radiators 36. The frequency of the antenna currents is equal to the difference in frequency between local oscillator signal LO1 and modulated local oscillator signal LO2′ (e.g., a frequency offset corresponding to wavelength offset X). The antenna currents may radiate THF signals 32 into free space. Control signal V_{BIAS} may control photomixer 42 to convert the optical local oscillator signals into antenna currents on radiators 36 (e.g., in a heterodyning operation) while preserving the modulation and thus the wireless data on modulated local oscillator signal LO2′ (e.g., by applying a squaring function to the signals). THF signals 32 may therefore carry the modulated wireless data for reception and demodulation by external wireless communications equipment.

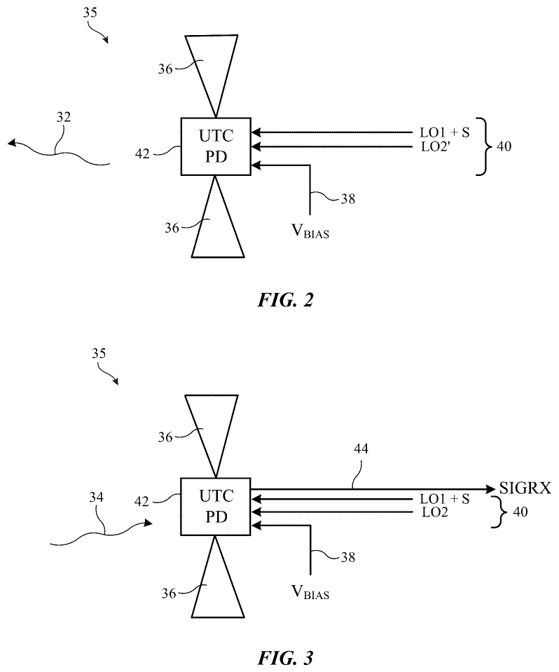

FIG. 3 is a diagram showing how wireless circuitry 35 may receive THF signals 34 (e.g., after changing the setting of control signals V_{BIAS} into a reception state from the transmission state of FIG. 2). As shown in FIG. 3, THF signals 34 may be incident upon radiators 36. The incident THF signals 34 may produce antenna currents that flow around the perimeter of radiators 36. Photomixer 42 may use optical local oscillator signal LO1 (plus the optical phase shift S when applied), optical local oscillator signal LO2 (e.g., without modulation), and control signals V_{BIAS} (e.g., a bias voltage asserted at the second level) to convert the received THF signals 34 into a receive signal (SIGRX) that is output onto signal path 44 (e.g., in a heterodyning operation).

The frequency of receive signal SIGRX is equal to the frequency of THF signals 34 minus the difference between the frequency of optical local oscillator signal LO1 and the frequency of optical local oscillator signal LO2. As an example, receive signal SIGRX may be at lower frequencies than THF signals 32 and 34 such as an intermediate frequency (FIF). Intermediate frequency FIF may be, as one example, a centimeter or millimeter wave frequency between 10 GHz and 100 GHz, between 30 GHz and 80 GHz, around 60 GHz, etc. Intermediate frequency FIF may be at a frequency lower than 10 GHz in other examples. Photomixer 42 may preserve the data modulation of THF signals 34 in receive signal SIGRX. A receiver in transceiver circuitry 26 (FIG. 1) may demodulate receive signal SIGRX (e.g., after further downconversion) to recover the wireless data from THF signals 34.

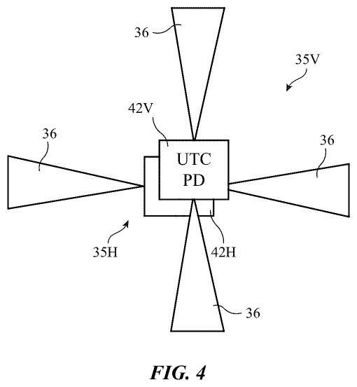

The wireless circuitry 35 of FIGS. 2 and 3 may support transmission of THF signals 32 and reception of THF signals 34 with a given polarization (e.g., a linear polarization such as a vertical polarization). If desired, wireless circuitry 24 (FIG. 1) may include multiple wireless circuitries 35 for covering different polarizations. FIG. 4 is a diagram showing one example of how wireless circuitry 24 may include multiple wireless circuitries 35 for covering different polarizations.

As shown in FIG. 4, the wireless circuitry may include first wireless circuitry 35V for covering a first polarization (e.g., a first linear polarization such as a vertical polarization) and may include second wireless circuitry 35H for covering a second polarization different from or orthogonal to the first polarization (e.g., a second linear polarization such as a horizontal polarization). Wireless circuitry 35V may include a photomixer 42 such as photomixer 42V coupled between a corresponding pair of radiators 36. Wireless circuitry 35H may include a photomixer 42 such as photomixer 42H coupled between a corresponding pair of radiators 36 oriented non-parallel (e.g., orthogonal) to the radiators 36 in wireless circuitry 35V. This may allow wireless circuitries 35V and 35H to transmit THF signals 32 with respective (orthogonal) polarizations and may allow wireless circuitries 35V and 35H to receive THF signals 32 with respective (orthogonal) polarizations.

To minimize space within device 10, wireless circuitry 35V may be vertically stacked over or under wireless circuitry 35H (e.g., where photomixer 42V partially or completely overlaps photomixer 42H). In this example, wireless circuitries 35V and 35H may both be formed on the same substrate such as a semiconductor substrate (e.g., a semiconductor chip, a semiconductor bulk, etc.), a rigid printed circuit board, or a flexible printed circuit. The radiators 36 in wireless circuitry 35V may, for example, be formed on a separate layer of the substrate than the radiators 36 in wireless circuitry 35H or the radiators 36 in wireless circuitry 35V may be formed on the same layer of the substrate as the radiators 36 in wireless circuitry 35H. Photomixer 42V may be formed on the same layer of the substrate as photomixer 42H or photomixer 42V may be formed on a separate layer of the substrate than photomixer 42H. Photomixer 42V may be formed on the same layer of the substrate as the radiators 36 in wireless circuitry 35V or may be formed on a separate layer of the substrate as the radiators 36 in wireless circuitry 35V. Photomixer 42H may be formed on the same layer of the substrate as the radiating element arms 36 in wireless circuitry 35H or may be formed on a separate layer of the substrate as the radiators 36 in wireless circuitry 35H.

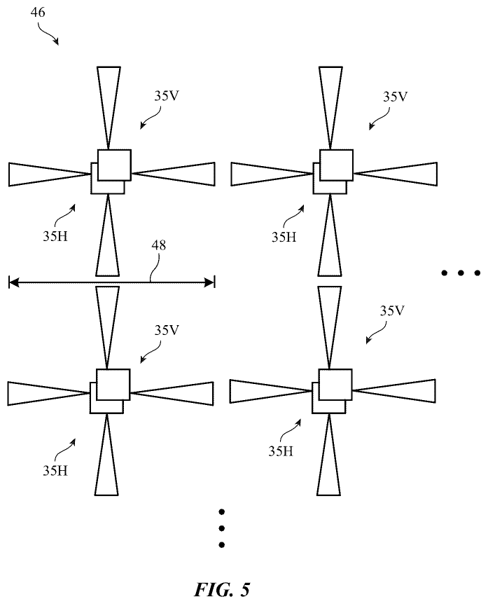

If desired, wireless circuitry 35 or wireless circuitries 35H and 35V of FIG. 4 may be integrated within a phased antenna array. FIG. 5 is a diagram showing one example of how wireless circuitries 35H and 35V may be integrated within a phased antenna array. As shown in FIG. 5, device 10 may include a phased antenna array 46 of stacked wireless circuitries 35H and 35V arranged in a rectangular grid of rows and columns. Each of the antennas in phased antenna array 46 may be formed on the same substrate. This is illustrative and non-limiting. In general, phased antenna array 46 (sometimes referred to as a phased array antenna) may include any desired number of wireless circuitries 35V and 35H (or non-stacked wireless circuitries 35) arranged in any desired pattern. Each of the antennas in phased antenna array 46 may be provided with a respective optical phase shift S (FIGS. 2 and 3) that configures the antennas to collectively transmit THF signals 32 that combine to form a signal beam of THF signals in a desired beam pointing direction and/or to receive THF signals 34 that coherently sum at device 10 from the desired beam pointing direction. The beam pointing direction may be selected to point the signal beam towards external communications equipment, towards a desired external object, away from an external object, etc.

Phased antenna array 46 may occupy relatively little space within device 10. For example, each wireless circuitry 35V/35H may have a length 48 (e.g., as measured from the end of one radiating element arm to the opposing end of the opposite radiating element arm). Length 48 may be approximately equal to one-half the wavelength of THF signals 32 and 34. For example, length 48 may be as small as 0.5 mm or less. Each photomixer 42 in phased antenna array 46 may occupy a lateral area of 100 square microns or less. The examples of FIGS. 2-5 are illustrative and non-limiting. In general, each antenna may have any desired antenna radiating element architecture.

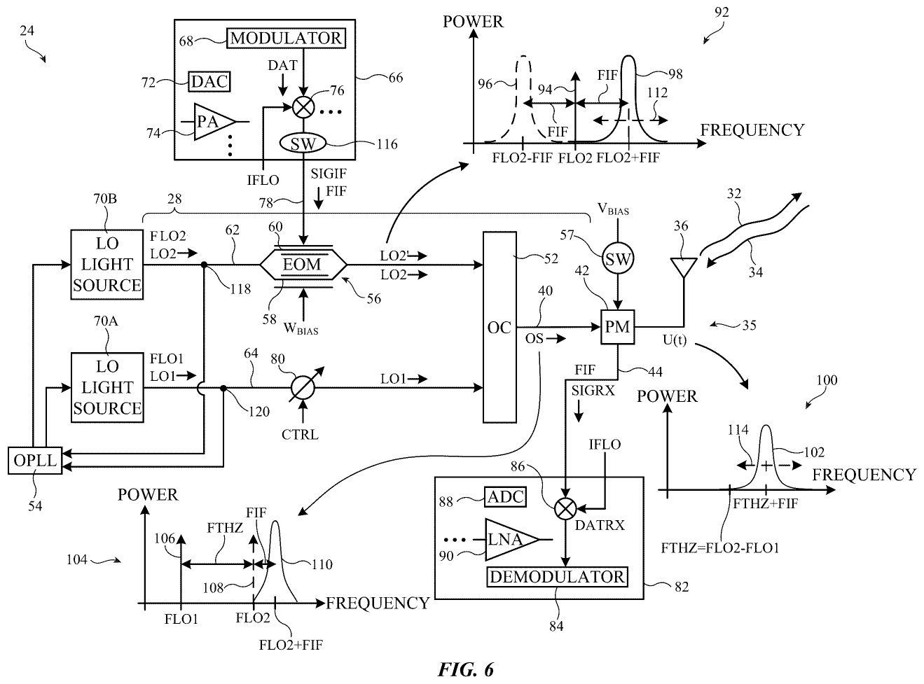

To further minimize area consumption on device 10, the same wireless circuitry 35 may be used to both transmit THF signals 32 and receive THF signals 34. Transceiver circuitry 26 may therefore include a reciprocal electro-optical transceiver that both transmits and receives wireless data using a given wireless circuitry 35 and using optical local oscillator signals LO1 and LO2. FIG. 6 is a circuit diagram of wireless circuitry 24 in an example where a single wireless circuitry 35 both transmits THF signals 32 and receives THF signals 34 based on optical local oscillator signals LO1 and LO2 generated by a reciprocal electro-optical transceiver in transceiver circuitry 26. In the example of FIG. 6, the electro-optical transceiver uses intermediate frequency signals to transmit and receive wireless data. The intermediate frequency signals are at intermediate radio frequencies that are higher than baseband but lower in frequency than THF signals 32 and 34.

As shown in FIG. 6, wireless circuitry 35 may include photomixer 42 and one or more radiators 36 coupled to photomixer 42. Wireless circuitry 24 may include radio-frequency transmitter circuitry such as intermediate frequency transmit (IFTX) chain 66, radio-frequency receiver circuitry such as intermediate frequency receive (IFRX) chain 82, and clocking circuitry such as a first optical local oscillator (LO) light source (emitter) 70A (sometimes referred to herein as LO light source 70A), a second optical LO light source 70B (sometimes referred to herein as LO light source 70B), and an electro-optical phase-locked loop (OPLL) 54. IFTX chain 66, IFRX chain 66, LO light sources 70A and 70B, and OPLL 54 may form part of an electro-optical transceiver in transceiver circuitry 26 (FIG. 1). The electro-optical transceiver may be coupled to wireless circuitry 35 over signal path 28. Photomixer 42 and/or signal path 28 may form part of the electro-optical transceiver in transceiver circuitry 26 or may be separate from transceiver circuitry 26.

Signal path 28 may include an optical signal path. Signal path 28 may also include a radio-frequency signal path such as signal path 44. Signal path 44 may be coupled to an electrical output terminal of photomixer 42. Photomixer 42 may also have an electrical input terminal (e.g., bias terminal 38 of FIGS. 2 and 3) that receives control signal V_{BIAS}. As described herein, radio-frequency signal paths may convey radio-frequency signals, including intermediate frequency signals, and may sometimes also be referred to herein as intermediate frequency signal paths, electrical signal paths, or simply as signal paths. The radio-frequency signal paths may include coaxial cables, stripline transmission lines, microstrip transmission lines, coplanar waveguide transmission lines, grounded coplanar waveguide transmission lines, and/or any other desired radio-frequency transmission lines that convey electrical signals at radio frequencies (e.g., intermediate frequencies).

The optical signal path in signal path 28 may include optical path 64 and optical path 62, an optical combiner such as optical combiner (OC) 52, and optical path 40. Optical path 62 may include an optical fiber or waveguide. Optical path 64 may include an optical fiber or waveguide. Optical combiner 52 may have a first input port (terminal) coupled to optical path 64, a second input port (terminal) coupled to optical path 62, and an output port (terminal) coupled to optical path 40. Optical path 40 may be optically coupled to the photomixer 42 in wireless circuitry 35 (e.g., may optically illuminate a photoactive portion of photomixer 42).

Optical path 62 may be coupled to the optical output of LO light source 70B (e.g., may optically couple the output of LO light source 70B to the second input port of optical combiner 52). Optical path 64 may be coupled to the optical output of LO light source 70A (e.g., may optically couple the output of LO light source 70A to the first input port of optical combiner 52). OPLL 54 may be coupled between the outputs of LO light sources 70A and 70B and control inputs of LO light sources 70A and 70B. For example, optical path 62 may include a node 118 (e.g., an optical splitter or optical coupler) coupled to an input of OPLL 54. Similarly, optical path 64 may include a node 120 (e.g., an optical splitter or optical coupler) coupled to an input of OPLL 54. OPLL 54 may have outputs coupled to the control inputs of LO light sources 70A and 70B.

LO light sources 70A and 70B may be any desired sources of electromagnetic energy, light, or optical energy such as laser light sources, laser diodes, etc. LO light source 70A may output (e.g., generate, produce, emit, etc.) a first optical local oscillator signal LO1 at a first optical frequency such as frequency FLO1 onto optical path 64. Frequency FLO1 may be a frequency in the visual spectrum, near-infrared spectrum, infrared spectrum, or ultraviolet spectrum. Similarly, LO light source 70B may output a second optical local oscillator signal LO2 at a second optical frequency such as frequency FLO2 onto optical path 62. Frequency FLO2 may be a frequency in the visual spectrum, near-infrared spectrum, infrared spectrum, or ultraviolet spectrum.

Frequency FLO2 may be offset from frequency FLO1 by a frequency offset that is equal to the frequency of the THF signals conveyed by wireless circuitry 35 (e.g., between 100 GHz and 1 THz, between 100 GHz and 2 THz, between 300 GHz and 800 GHz, between 300 GHz and 1 THz, between 300 and 400 GHz, between 100 GHz and 300 GHz, etc.). Consider one example in which frequency FLO1 is equal to 200,000 GHz and frequency FLO2 is equal to 200,300 GHz. In this example, the frequency offset is equal to 200,300 GHz-200,000 GHz=300 GHz and optical local oscillator signals LO1 and LO2 may drive photomixer 42 to convey THF signals 32 and/or 34 at a frequency of 300 GHz.

The high frequency of THF signals 32 and 34 cause wireless circuitry 24 to be particularly sensitive to phase noise and jitter that can deteriorate wireless performance. OPLL 54 may help to minimize phase noise and jitter in wireless circuitry 24. OPLL 54 may include one or more control/feedback loops that are used to minimize phase noise and jitter in the optical local oscillator signals LO1 and LO2 output by LO light sources 70A and 70B. OPLL 54 may, for example, include one or more phase-locked loops (PLLs), self-injection locked loops, and/or frequency-locked loops (FLLs) around LO light sources 70A and 70B. OPLL 54 may include one or more photodetectors, mixers, filters (e.g., loop filters), optical paths, electrical paths, clocking circuits, frequency discriminators, and/or other circuitry for phase locking, frequency locking, and/or self-injection locking LO light source 70B to LO light source 70A or vice versa.

For example, OPLL 54 may receive optical local oscillator signals LO1 and/or LO2 over optical paths 62 and/or 64, may measure the phase of optical local oscillator signals LO1 and/or LO2, and may provide control signals to the control inputs of LO light sources 70A and/or 70B that adjust the phase of the optical local oscillator signals LO1 and/or LO2 output by LO light sources 70A and/or 70B. These adjustments may be performed in one or more iterations until the phase of the optical local oscillator signal LO1 output by LO light source 70A is locked to the phase of the optical local oscillator signal LO2 output by LO light source 70B (e.g., until LO light source 70B is phase-locked to LO light source 70A). When phase-locked, time fluctuations (e.g., phase variations) in LO light source 70B and thus optical local oscillator signal LO2 will tightly follow any fluctuations in LO light source 70A and thus optical local oscillator signal LO1. This may configure the separation in frequency and phase between optical local oscillator signal LO1 and optical local oscillator signal LO2 to be constant over time, which configures components clocked using optical local oscillator signals LO1 and LO2 (e.g., wireless circuitry 35) to exhibit extremely stable performance over time (e.g., insensitive to phase noise and jitter).

An electro-optical modulator such as electro-optical modulator (EOM) 56 may be disposed on optical path 62 between node 118 and optical combiner 52. EOM 56 may be, for example, a Mach-Zehnder modulator (MZM) or any other desired type of EOM that modulates an optical signal using an electrical signal received from IFTX chain 66. EOM 56 may include a first optical arm (branch) 60 and a second optical arm (branch) 58 coupled in parallel with arm 60 on optical path 62. EOM 56 may include one or more electrodes extending along either side of arm 60 and one or more electrodes extending along either side of arm 58. Electrical signals applied to the electrodes (e.g., voltage signals applied across the arms) may control EOM 56 to modulate information (e.g., wireless signals) from the electrical signals onto the optical local oscillator signal LO2 conveyed over optical path 62.

If desired, an optical phase shifter such as optical phase shifter 80 may be disposed on optical path 64 between node 120 and optical combiner 52. Control circuitry 14 (FIG. 1) may provide phase control signals CTRL to optical phase shifter 80. Phase control signals CTRL may control optical phase shifter 80 to apply optical phase shift S (FIGS. 2 and 3) to the optical local oscillator signal LO1 on optical path 64. Phase shift S may be selected to steer a signal beam of THF signals 32/34 in a desired pointing direction. Optical phase shifter 80 may pass the phase-shifted optical local oscillator signal LO1 (denoted as LO1+S in FIGS. 2 and 3) to optical combiner 52. Additionally or alternatively, EOM 56 may impart phase shift S to optical local oscillator signal LO2.

Signal beam steering is performed in the optical domain (e.g., using optical phase shifter 80) rather than in the THF domain because there are no satisfactory phase shifting circuit components that operate at frequencies as high as the frequencies of THF signals 32 and 34. Optical combiner 52 may receive optical local oscillator signal LO2 over optical path 62. Optical combiner 52 may combine optical local oscillator signals LO1 and LO2 onto optical path 40 (as optical signal OS), which directs the optical local oscillator signals (in optical signal OS) onto photomixer 42 for use during signal transmission or reception. Optical phase shifter 80 may be omitted if desired.

IFTX chain 66 may include electrical components for transmitting wireless data in the THF signals 32 transmitted by wireless circuitry 35. IFTX chain 66 may, for example, include data modulation (encoding) circuitry such as modulator 68, upconversion circuitry such as mixer 76, amplifier circuitry such as one or more power amplifiers (PAs) 74, conversion circuitry such as one or more digital-to-analog converters (DACs) 72, switching circuitry such as one or more switches 116, and/or other circuitry that modulates wireless data onto optical local oscillator signal LO2 using EOM 60. Mixer 76 may have a first input coupled to the output of modulator 68, a second input that receives an intermediate local oscillator signal IFLO (e.g., from electrical clocking circuitry in wireless circuitry 24 such as an electrical local oscillator), and an output coupled to transmit data path 78. Transmit data path 78 (e.g., a radio-frequency signal path) may be coupled to one or more electrodes on one or both of arms 60 and 58 of EOM 56. If desired, IFTX chain 66 may include multiple mixers 76 for performing multiple stages of upconversion from baseband to an intermediate frequency.

IFRX chain 82 may include electrical components for receiving wireless data in the THF signals 34 incident upon wireless circuitry 35. IFRX chain 82 may, for example, include data demodulation (decoding) circuitry such as demodulator 84, downconversion circuitry such as mixer 86, amplifier circuitry such as one or more low noise amplifiers (LNAs) 90, conversion circuitry such as one or more analog-to-digital converters (ADCs) 88, and/or other circuitry that recovers wireless data from the THF signals 34 incident upon wireless circuitry 35. Mixer 86 may have a first input coupled to signal path 44, a second input that receives intermediate local oscillator signal IFLO, and an output coupled to the input of demodulator 84. If desired, IFRX chain 82 may include multiple mixers 86 for performing multiple stages of downconversion from an intermediate frequency to baseband.

Wireless circuitry 24 may switch between transmitting THF signals 32 at a given THF frequency and receiving THF signals 34 at the same THF frequency during different respective time periods using a time division duplexing (TDD) scheme. In practice, it can be very challenging to reconfigure a reciprocal electro-optical transceiver to switch between transmitting THF signals and receiving THF using the same photomixer of the same antenna over time. In some implementations, the antenna transmits THF signals at a first frequency (e.g., a THF frequency) but receives THF signals at a second frequency different from the first frequency (e.g., the THF frequency plus an intermediate frequency). This requires a change to the frequency FLO2 of the optical local oscillator signal LO2 output by LO light source 70B and/or a change to the frequency FLO1 of the optical local oscillator signal LO1 output by LO light source 70A to properly reconfigure photomixer 42 each time the antenna switches between signal transmission and signal reception.

However, each time frequency FLO1 or FLO2 is changed, OPLL 54 needs to re-lock LO light source 70B to LO light source 70A to ensure minimal phase noise in the conveyed THF signals. Phase-locking the LO light sources using OPLL 54 consumes a finite amount of time and/or resources in device 10. As such, re-locking the light sources every time the antenna switches between different over-the-air frequencies (e.g., each time the antenna switches between transmitting THF signals 32 and receiving THF signals 34 under its TDD scheme and/or each time device 10 is scheduled different frequency resources by its corresponding wireless network) can cause significant delay or disruption to the transmission and reception of wireless data using the antenna. It would therefore be desirable for wireless circuitry 24 to be able to transmit THF signals 32 and to receive THF signals 34 at the same THF frequency without adjusting the frequency FLO2 of optical local oscillator signal LO2 or the frequency FLO1 of optical local oscillator signal LO1.

In embodiments that are described herein as an example, wireless circuitry 24 may switch between transmitting THF signals 32 and receiving THF signals 34 at the same over-the-air THF frequency without adjusting LO light sources 70A and 70B, by instead adjusting the operation of EOM 56 and IFTX chain 66 between the transmission of THF signals 32 and the reception of THF signals 34. This may allow wireless circuitry 24 to switch between THF signal transmission and reception without adjusting frequency FLO1 of optical local oscillator signal LO1, without adjusting frequency FLO2 of optical local oscillator signal LO2, and without using OPLL 54 to re-lock LO light sources 70A and 70B together, thereby minimizing delays or disruptions to wireless communication.

First consider the transmission of THF signals 32 by wireless circuitry 24. Wireless circuitry 24 is sometimes referred to herein as being in a transmit mode or state when transmitting THF signals 32. During signal transmission (in the transmit mode of wireless circuitry 24), LO light source 70B outputs optical local oscillator signal LO2 at frequency FLO2 onto optical path 62. LO light source 70A outputs optical local oscillator signal LO1 at frequency FLO1 onto optical path 64. Optical path 64 passes optical local oscillator signal LO1 to optical combiner 52 (e.g., with an optional phase shift S as shown in FIGS. 2 and 3).

IFTX chain 66 may generate wireless data DAT for transmission via THF signals 32. Modulator 68 (e.g., in baseband circuitry in IFTX chain 66) may generate wireless data DAT (e.g., baseband data as modulated onto a baseband signal). DAC 72 may convert the baseband signal from the digital domain to the analog domain. Intermediate local oscillator signal IFLO may be at an intermediate frequency that is higher than baseband and lower than the THF frequency of THF signals 32/34. The intermediate frequency may be between 1-100 GHz, as an example. Mixer 76 may mix the baseband signal containing wireless data DAT onto intermediate local oscillator signal IFLO to generate intermediate frequency signal SIGIF. Intermediate frequency signal SIGIF is at intermediate frequency FIF (e.g., includes wireless data DAT modulated onto a carrier at intermediate frequency FIF). Intermediate frequency FIF may be between 1-100 GHz, as an example. PA 74 may amplify intermediate frequency signal SIGIF. IFTX chain 66 may transmit intermediate frequency signal SIGIF to one or more electrodes of EOM 56 via transmit data path 78 (e.g., an intermediate frequency signal path).

EOM 56 may modulate intermediate frequency signal SIGIF and thus the wireless data DAT in intermediate frequency signal SIGIF onto the optical local oscillator signal LO2 on optical path 62 to generate (e.g., produce, output, etc.) modulated optical local oscillator signal LO2′. Propagating optical local oscillator signal LO2 along arms 60 and 58 of EOM 56 may impart, in the presence of a voltage signal applied to one or both arms (e.g., a voltage signal of intermediate frequency signal SIGIF), different optical phase shifts on each arm before recombining the signal at the output of EOM 56 (e.g., where optical phase modulations produced on the arms are converted to intensity modulations at the output of EOM 56). When the voltage applied to EOM 56 includes wireless data DAT from intermediate frequency signal SIGIF, EOM 56 modulates the wireless data DAT onto optical local oscillator signal LO2. EOM 56 may receive one or more bias voltages WBIAS (sometimes referred to herein as bias signals WBIAS) applied to one or both of arms 58 and 60. Control circuitry 14 (FIG. 1) may provide bias voltage WBIAS with different magnitudes to place EOM 56 into different operating modes (e.g., operating modes that suppress optical carrier signals, operating modes that do not suppress optical carrier signals, etc.).

To configure wireless circuitry 24 to transmit THF signals 32 at the same over-the-air frequency as when receiving THF signals 34, bias voltage WBIAS may be asserted at a first level that configures EOM 56 to perform single sideband carrier suppression (SSB-CS) on optical local oscillator signal LO2. This produces a modulated optical local oscillator signal LO2′ having one of its sidebands suppressed.

Plot 92 in FIG. 6 plots the power spectrum (power as a function of frequency) of modulated optical local oscillator signal LO2′ after SSB-CS by EOM 56. Without sideband suppression, modulating optical local oscillator signal LO2 using intermediate frequency signal SIGIF at EOM 56 produces an output having a carrier signal at the frequency FLO2 of optical local oscillator signal LO2 (shown by peak 94) as well as a first sideband signal (shown by curve 96) that is lower than frequency FLO2 by the intermediate frequency FIF of intermediate frequency signal SIGIF (e.g., centered at frequency FLO2−FIF) and a second sideband signal (shown by curve 98) that is higher than frequency FLO2 by the intermediate frequency FIF of intermediate frequency signal SIGIF (e.g., centered at frequency FLO2+FIF). The sideband at frequency FLO2−FIF is sometimes referred to herein as the lower sideband of the carrier at frequency FLO2. The sideband at frequency FLO2+FIF is sometimes referred to herein as the upper sideband of the carrier at frequency FLO2.

When EOM 56 is configured by bias voltage WBIAS to perform SSB-CS, the modulated optical local oscillator signal LO2′ output by EOM 56 only includes a single sideband signal whereas the other sideband signal is suppressed (e.g., filtered out, blocked, or removed). The carrier signal (peak 94) may also be suppressed if desired. In the example of FIG. 6, the lower sideband signal (curve 96) is suppressed, leaving the upper sideband signal (curve 98) in modulated optical local oscillator signal LO2′. In other words, modulated optical local oscillator signal LO2′ is at frequency FLO2+FIF. This is illustrative and non-limiting. If desired, the upper sideband signal may be suppressed to leave the lower sideband signal at frequency FLO2−FIF in modulated optical local oscillator signal LO2′. The wireless data DAT from intermediate frequency signal SIGIF is modulated onto the sideband signal in modulated optical local oscillator signal LO2′. Modulation with wireless data DAT causes curve 98 to exhibit a finite bandwidth, as shown in plot 92. EOM 56 passes modulated optical local oscillator signal LO2′ to optical combiner 52.

Optical combiner 52 may combine the optical signal on optical path 62 with the optical signal on optical path 64 to output optical signal OS on optical path 40. Optical path 40 illuminates photomixer 42 using optical signal OS. When wireless circuitry 24 is in the transmit mode, optical signal OS is denoted herein as optical signal OS′. In the transmit mode, optical combiner 52 combines the modulated optical local oscillator signal LO2′ on optical path 62 with the optical local oscillator signal LO1 on optical path 64 to generate optical signal OS' on optical path 40.

Plot 104 in FIG. 6 plots the power spectrum of optical signal OS' on optical path 40. Peak 106 in plot 104 represents optical local oscillator signal LO1 at frequency FLO1. Peak 108 in plot 104 represents optical local oscillator signal LO2 at frequency FLO2. Curve 110 in plot 104 represents the single (unsuppressed) sideband at frequency FLO2+FIF in modulated optical local oscillator signal LO2′ (corresponding to curve 98 in plot 92). Frequency FLO2 is separated from frequency FLO1 by THF frequency FTHZ (e.g., between 100 GHz and 1 THz, between 100 GHz and 2 THz, between 300 GHz and 800 GHz, between 300 GHz and 1 THz, between 300 and 400 GHz). Optical signal OS' may include optical local oscillator signal LO1 (peak 106) and the single sideband signal from modulated optical local oscillator signal LO2′ (curve 110 at frequency FLO2+FIF). The portion of optical signal OS' from modulated optical local oscillator signal LO2′ (at frequency FLO2+FIF) may therefore be separated from the portion of optical signal OS' from optical local oscillator signal LO1 (at frequency FLO1) by a frequency offset equal to FTHZ+FIF.

Optical path 40 illuminates photomixer 42 using optical signal OS′. Photomixer 42 may receive a control signal V_{BIAS} at a first setting (e.g., a first, non-zero, bias voltage level) that configures photomixer 42 to generate a radio-frequency signal (antenna current) U(t) on radiator(s) 36 (e.g., using a heterodyning process). The frequency of radio-frequency signal U(t) is given by the frequency difference (offset) between optical local oscillator signal LO1 and the modulated single sideband from modulated optical local oscillator signal LO2. In other words, the carrier frequency of radio-frequency signal U(t) may be equal to FTHZ+FIF. Plot 100 in FIG. 6 plots the power spectrum of radio-frequency signal U(t) on optical path 40. As shown by curve 102, radio-frequency signal U(t) is at frequency FTHZ+FIF (e.g., the frequency separation between peak 106 and curve 110 of plot 104), where frequency FTHZ is given by FLO2−FLO1.

Radiator(s) 36 may radiate radio-frequency signal U(t) into free space as THF signals 32. Radio-frequency signal U(t) and THF signals 32 include wireless data DAT modulated onto the signal at frequency FTHZ+FIF. As such, curve 102 of plot 100 has a finite bandwidth. Wireless circuitry 24 may switch to receiving THF signals 34 at the same frequency FTHZ+FIF without adjusting LO light sources 70A and 70B and without adjusting frequencies FLO1 and FLO2.

Now consider the reception of THF signals 34 by wireless circuitry 24. Wireless circuitry 24 is sometimes referred to herein as being in a receive mode or state when receiving THF signals 34. During signal reception (in the receive mode of wireless circuitry 24), LO light source 70B outputs optical local oscillator signal LO2 at frequency FLO2 onto optical path 62. LO light source 70A outputs optical local oscillator signal LO1 at frequency FLO1 onto optical path 64. Optical path 64 passes optical local oscillator signal LO1 to optical combiner 52 (e.g., with an optional phase shift S as shown in FIGS. 2 and 3). OPLL 54 does not need to re-lock the phase of LO light source 70B to the phase of LO light source 70A since frequencies FLO1 and FLO2 are unchanged between the transmit and receive modes.

Plot 100 of FIG. 6 also plots the power spectrum of the THF signals 34 incident upon radiator(s) 36. THF signals 34 may include wireless receive data DATRX. Radiator(s) 36 may produce radio-frequency signal U(t) on photomixer 42 at frequency FTHZ+FIF from the incident THF signals 34. Wireless receive data DATRX is modulated onto radio-frequency signal U(t) at a carrier frequency FTHZ+FIF (e.g., by external communications equipment or by device 10 when THF signals 34 represent reflected THF signals 32 as used in spatial ranging).

In the receive mode, IFTX chain 66 does not modulate wireless data onto intermediate frequency signals SIGIF. If desired, IFTX chain 66 may forego generation of intermediate frequency signals SIGIF in the receive mode to conserve power. For example, IFTX chain 66 may be disabled, inactive, powered down, idle, or asleep in the receive mode. Alternatively, switch 116 may be opened to produce an open circuit impedance on transmit data path 78 that prevents intermediate frequency signals SIGIF from passing to EOM 56. If desired, in the receive mode, bias voltage WBIAS may be asserted at a second level (e.g., may be turned off or asserted at a magnitude of zero) to configure EOM 56 to pass optical local oscillator signal LO2 without modulation. Alternatively, in the receive mode, IFTX chain 66 may still transmit intermediate frequency signals SIGIF to EOM 56 and EOM 56 may still generate a single sideband carrier signal by modulating intermediate frequency signals SIGIF (without modulations from wireless data DAT) onto optical local oscillator signal LO2. This may, for example, allow wireless circuitry 24 to tune the frequency with which THF signals 34 are received without adjusting LO light sources 70. In these examples, the EOM 56 is still referred to herein as outputting optical local oscillator signal LO2 (e.g., because no wireless data DAT is modulated onto optical local oscillator signal LO2). EOM 56 may therefore pass optical local oscillator signal LO2 to optical combiner 52 in the receive mode.

Optical combiner 52 may combine the optical signal on optical path 62 with the optical signal on optical path 64 to output an optical signal OS″ on optical path 40. Optical path 40 illuminates photomixer 42 using optical signal OS″. Optical signal OS″ is represented by peaks 106 and 108 in plot 104, separated by frequency FTHZ=FLO2−FLO1. Photomixer 42 may receive a control signal V_{BIAS} at a second setting (e.g., a second bias voltage level) that configures photomixer 42 to generate a receive signal SIGRX on signal path 44 based on optical signal OS″ and radio-frequency signal U(t). The second bias voltage level may be zero (e.g., the bias voltage may be removed or decoupled from photomixer 42 in the receive mode, such as by opening a switch 57 coupled between a source of the bias voltage and the bias terminal of photomixer 42). This configures photomixer 42 to first mix the optical local oscillator signal LO1 in optical signal OS″ with the optical local oscillator signal LO2 in optical signal OS″, recovering a signal at a frequency given by the difference in frequency between optical LO signals LO1 and LO2 (e.g., at frequency FTHZ=FLO2−FLO1 in a first heterodyne process). Photomixer 42 may then mix that signal with the incident radio-frequency signal U(t) at frequency FTHZ+FIF to recover receive signal SIGRX at a frequency given by the difference between the frequency of radio-frequency signal U(t) and the signal produced by heterodyning the optical LO signals LO1 and LO2 in optical signal OS″ (e.g., in a second heterodyne process). As such, photomixer 42 may generate (output) receive signal SIGRX onto signal path 44 at a frequency equal to (FTHZ+FIF)−FTHZ=FIF, or the same intermediate frequency that is used to modulate optical local oscillator LO2 in the transmit mode.

For example, during signal reception, the conductance G(t) of photomixer 42 is proportional to the optical power received over optical path 40 (e.g., where G(t)=g*P_{OPT}(t), P_{OPT}(t) is the optical power of optical signal OS″, and g is a constant corresponding to the sensitivity of photomixer 42). Optical power P_{OPT}(t) is proportional to |E₁+E₂|², where E₁ is the electrical field from optical local oscillator signal LO1 and where E₂ is the electrical field from optical local oscillator signal LO1. Er is given by the equation E₁(t)=E₁₀*exp(j*((ω₁*t+Δϕ))) and E₂ is given by the equation E₂(t)=E₂₀*exp(j*((ω₂*t+Δϕ))), where ω₁ is the angular frequency of optical local oscillator signal LO1, ω₂ is the angular frequency of optical local oscillator signal LO2, E₁₀ is the amplitude of optical local oscillator signal LO1, E₂₀ is the amplitude of optical local oscillator signal LO2, and Δϕ is the phase shift of optical local oscillator signal LO1 relative to optical local oscillator signal LO2 (e.g., as locked using OPLL 54).

Substituting the expressions for E₁ and E₂ into the expression for optical power P_{OPT}(t) and expanding gives that optical power P_{OPT}(t) is proportional to |E₁|²+|E₂|²+2*E₁₀*E₂₀*cos ((ω₂−ω₁)*t+Δϕ+ΔϕTHZ), where Δϕ_{THZ} is the phase of the incident THF signals 34. The output current I_{OUT}(t) of photomixer 42 (e.g., on signal path 44) is equal to U(t)*G(t), where U(t)=U₀*cos(ω_{THZ}*t+Δϕ_{THZ}), U₀ is the amplitude of the incident THF signals 34, and ω_{THZ} is the angular frequency of the incident THF signals 34 (e.g., the angular frequency corresponding to FTHZ+FIF). Equation 1 shows how the expressions for G(t) and P_{OPT}(t) may be combined into the expression for output current I_{OUT}(t), which may expanded as shown by equation 2.

$${I}_{O U T} ( t ) = U ( t ) G ( t ) ∝ g ( D C ) {U}_{0} cos ( {ω}_{T H Z} t ) + 2 g {E}_{01} {E}_{02} {U}_{0} cos ( ( {ω}_{2} - {ω}_{2} ) t + Δϕ ) cos ( {ω}_{T H Z} t ) \qquad ( 1 )$$

$${I}_{O U T} ( t ) ∝ g ( D C ) {U}_{0} cos ( {ω}_{T H Z} t ) + 2 g {E}_{01} {E}_{02} {U}_{0} cos ( ( {ω}_{2} - {ω}_{2} - {ω}_{T H Z} ) t + Δ ϕ + Δ {ϕ}_{T H Z} ) + 2 g {E}_{01} {E}_{02} {U}_{0} cos ( ( {ω}_{2} - {ω}_{2} + {ω}_{T H Z} ) t + Δ ϕ + Δ {ϕ}_{T H Z} ) \qquad ( 2 )$$

In equation 2, the second term in the sum represents the current output onto signal path 44 by photomixer 42 at intermediate frequency FIF (as receive signal SIGRX), because the angular frequency (ω₂−ω₁−ω_{THZ}) is equivalent to the angular frequency associated with intermediate frequency FIF. As such, photomixer 42 effectively detects the amplitude and phase of the incident THF signals 34 as an intermediate frequency output current (receive signal SIGRX) at intermediate frequency FIF. If desired, the other terms in the sum for output current I_{OUT}(t) may be filtered or removed.

Signal path 44 may pass receive signal SIGRX (e.g., an intermediate frequency signal) to IFRX chain 82. LNA 90 may amplify receive signal SIGRX. Mixer 86 may mix receive signal SIGRX with intermediate frequency local oscillator signal IFLO to output a baseband signal that includes wireless data DATRX (sometimes also referred to herein as wireless receive data or received data). ADC 88 may convert the baseband signal from the analog domain to the digital domain. Demodulator 84 may recover, extract, decode, and/or demodulate receive data DATRX from the baseband signal. Demodulator 84 may pass wireless data DATRX to other circuitry (e.g., an applications processor) for further processing.

In this way, wireless circuitry 24 may both transmit wireless data DAT via THF signals 32 at a given carrier frequency FTHZ+FIF and receive wireless data DATRX via THF signals 34 at the same carrier frequency FTHZ+FIF using the same wireless circuitry 35 (thereby minimizing device volume), without requiring adjustment to LO light sources 70A/70B or re-locking with OPLL 54, which minimizes disruptions to wireless communication as well as phase noise and jitter.

If desired, wireless circuitry 24 may tune the frequency used to transmit THF signals 32 by adjusting IFTX 66 without adjusting LO light sources 70A and 70B or using OPLL 54 to re-lock the light sources. For example, during signal transmission, the frequency of intermediate local oscillator signal IFLO may be adjusted to adjust the intermediate frequency FIF of the intermediate frequency signal SIGIF provided to EOM 56. This shifts the frequency of the modulated single sideband in the modulated optical local oscillator signal LO2′ output by EOM 56, as shown by arrow 112 in plot 92. This shift in frequency also shifts the frequency separation optical local oscillator signal LO1 and the modulated single sideband in optical signal OS' (i.e., the frequency separation between curve 110 and peak 106 in plot 104), causing a corresponding frequency shift in the radio-frequency signal U(t) output by photomixer 42 (as shown by arrow 114 in plot 100).

Similarly, wireless circuitry 24 may tune the frequency used to receive THF signals 34 by adjusting IFTX chain 66 without adjusting LO light sources 70A and 70B or using OPLL 54 to re-lock the light sources. For example, during signal reception, IFTX chain 66 may still supply an intermediate frequency signal SIGIF to EOM 56 (e.g., without wireless data DAT modulated onto the intermediate frequency signal) and may tune frequency of the intermediate local oscillator signal IFLO provided to mixer 76. This tunes the intermediate frequency FIF of intermediate frequency signal SIGIF. EOM 56 may electro-optically modulate second optical local oscillator signal LO2 with intermediate frequency signal SIGIF using SSB-CS to produce a corresponding single sideband that is shifted relative to frequency FLO2 according to the adjustment in intermediate frequency FIF (as shown by arrow 112 of plot 92). Note that in this example, since wireless data DAT is not modulated onto the single sideband, the single sideband will exhibit a very narrow bandwidth and the output of EOM 56 is still denoted herein as optical local oscillator signal LO2 rather than modulated optical local oscillator signal LO2′. Since the bandwidth of EOM 56 is relatively large, wireless circuitry 24 may tune the over-the-air frequency of THF signals 32 and 34 in this way (e.g., without adjusting frequencies FLO1 or FLO2) over a relatively large bandwidth (e.g., over a range of frequencies spanning as much as 500 GHZ).

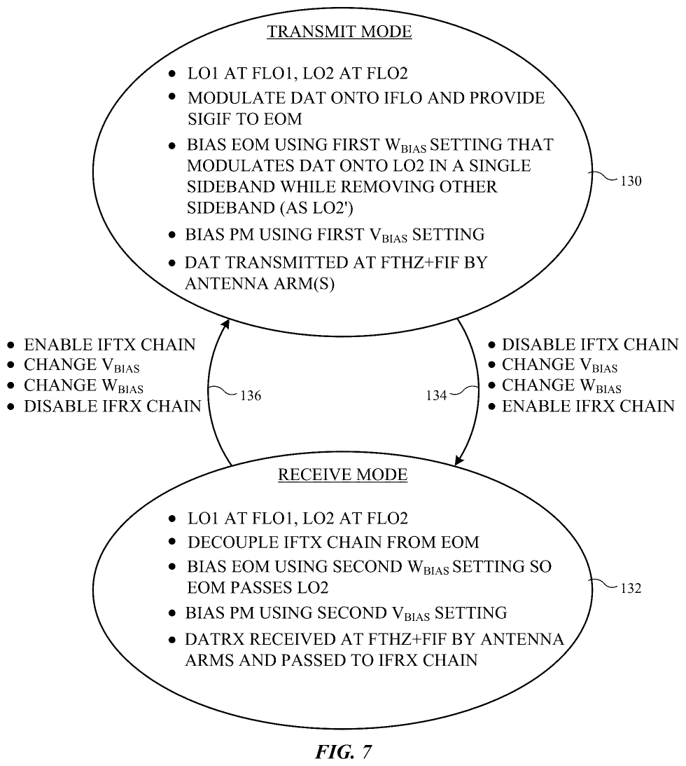

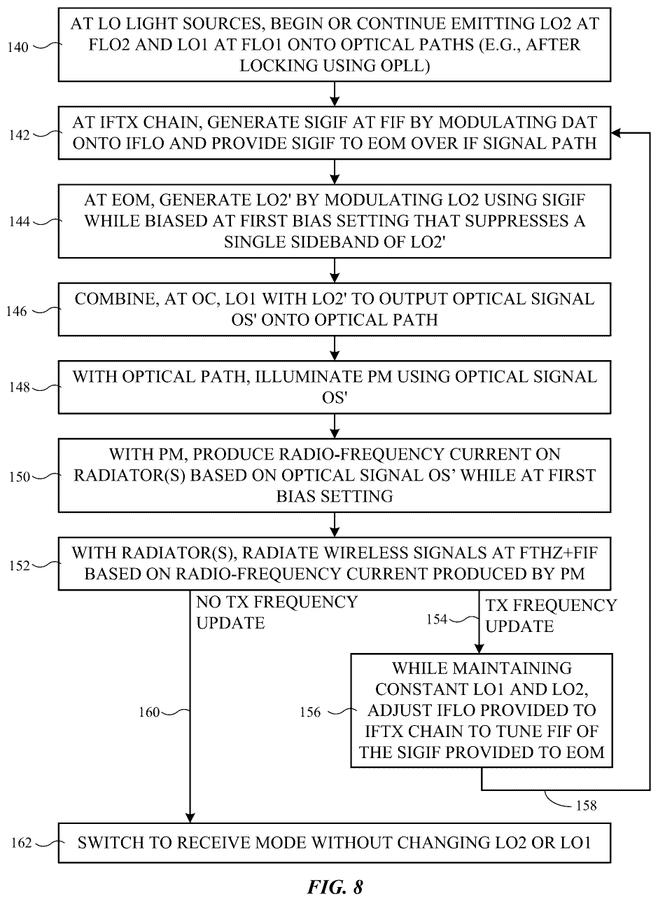

FIG. 7 is a state diagram of illustrative operating modes used by wireless circuitry 24 to transmit and receive THF signals. As shown in FIG. 7, wireless circuitry 24 may be operable in a transmit mode (state) 130 or in a receive mode (state) 132. In transmit mode 130 (e.g., during a first time period), LO light source 70B outputs optical local oscillator signal LO2 at frequency FLO2. LO light source 70A outputs optical local oscillator signal LO1 at frequency FLO1. IFTX chain 66 generates wireless data DAT and modulates wireless data DAT onto intermediate frequency signal SIGIF at intermediate frequency FIF using intermediate frequency local oscillator signal IFLO. Transmit data path 78 provides the intermediate frequency signal SIGIF containing wireless data DAT to EOM 56.

EOM 56 may be biased using a first setting of bias voltage WBIAS. The first setting of bias voltage WBIAS configures EOM 56 to modulate optical local oscillator signal LO2 using intermediate frequency signal SIGIF and SSB-CS, producing modulated optical local oscillator signal LO2′. Photomixer 42 may be biased using a first setting of control signal V_{BIAS} (e.g., a non-zero bias voltage). Photomixer 42 may generate radio-frequency signal U(t) by heterodyning the first optical local oscillator signal LO1 in optical signal OS' with the single sideband from modulated optical local oscillator signal LO2′ in optical signal OS' while biased using the first setting of control signal V_{BIAS}. Radio-frequency signal U(t) may include wireless data DAT modulated onto a carrier at frequency FTHZ+FIF. Radiator(s) 36 may transmit THF signals 32 into free space.

Wireless circuitry 24 may switch from transmit mode 130 to receive mode 132, as shown by arrow 134, in response to any desired trigger condition (e.g., under a TDD scheme). Wireless circuitry 24 may switch from transmit mode 130 to receive mode 132 by disabling, stopping, or deactivating data modulation by IFTX chain 66, adjusting the control signal V_{BIAS} provided to photomixer 42, adjusting the bias voltage WBIAS provided to EOM 56, and/or by enabling, activating, or switching IFRX chain 82 into use. Wireless circuitry 24 may forego any adjustment to light sources 70A/70B, optical local oscillator signals LO1/LO2, and frequencies FLO1 and FLO2 when switching from transmit mode 130 to receive mode 132. OPLL 54 may forego re-locking of light sources 70A/70B when switching from transmit mode 130 to receive mode 132.

In receive mode 132 (e.g., during a second time period different from the first time period), LO light source 70B continues to output optical local oscillator signal LO2 at frequency FLO2. LO light source 70A continues to output optical local oscillator signal LO1 at frequency FLO1. IFTX chain 66 does not generate wireless data DAT and/or does not modulate wireless data DAT onto intermediate frequency signal SIGIF at intermediate frequency FIF. Transmit data path 78 may still provide intermediate frequency signal SIGIF (e.g., without wireless data modulated thereon) to EOM 56 or may forego transmission of intermediate frequency signal SIGIF to EOM 56.

EOM 56 may be biased using a second setting of bias voltage WBIAS different from the first setting (e.g., bias voltage WBIAS may be de-asserted or decoupled from EOM 56). Alternatively, EOM 56 may continue to be biased at the first setting of bias voltage WBIAS. Photomixer 42 may be biased using a second setting of control signal V_{BIAS} (e.g., a bias voltage of zero or a setting in which control signal V_{BIAS} is decoupled from or de-asserted from the bias terminal of photomixer 42). Wireless circuitry 35 may receive incident THF signals 34 at the same frequency as the transmitted THF signals 32 (e.g., at frequency FTHZ+FIF). THF signals 34 may have wireless data DATRX modulated thereon (e.g., at a carrier frequency equal to FTHZ+FIF). Photomixer 42 may generate receive signal SIGRX at intermediate frequency FIF by heterodyning the optical local oscillator signal LO1 in optical signal OS″ with the optical local oscillator signal LO2 in optical signal OS″ and with the incident THF signals 34 (e.g., radio-frequency signal U(t) of FIG. 6) while biased using the second setting of control signal V_{BIAS}. IFRX chain 82 may extract/recover wireless data DATRX from intermediate frequency signal SIGIF.

Wireless circuitry 24 may switch from receive mode 132 to transmit mode 130, as shown by arrow 136, in response to any desired trigger condition (e.g., under a TDD scheme). Wireless circuitry 24 may switch from receive mode 132 to transmit mode 130 by enabling, activating, or beginning data modulation by IFTX chain 66, adjusting the control signal V_{BIAS} provided to photomixer 42, adjusting the bias voltage WBIAS provided to EOM 56, and/or by disabling, deactivating, or decoupling IFRX chain 82 from use. Wireless circuitry 24 may forego any adjustment to light sources 70A/70B, optical local oscillator signals LO1/LO2, and frequencies FLO1 and FLO2 when switching from receive mode 132 to transmit mode 130. OPLL 54 may forego re-locking of light sources 70A/70B when switching from receive mode 132 to transmit mode 130.

FIG. 8 is a flow chart of operations that may be performed by wireless circuitry 24 to transmit THF signals 32 at frequency FTHZ+FIF while in transmit mode 130. At operation 140, LO light sources 70A and 70B may begin or continue emitting optical local oscillator signal LO2 at frequency FLO2 and optical local oscillator signal LO1 at frequency FLO1 onto optical paths 62 and 64 respectively (e.g., after phase locking by OPLL 54).

At operation 142, IFTX chain 66 may generate intermediate frequency signal SIGIF at intermediate frequency FIF by modulating wireless data DAT onto intermediate frequency local oscillator signal IFLO. IFTX chain 66 may transmit intermediate frequency SIGIF to EOM 56 over transmit data path 78.

At operation 144, EOM 56 may generate (output, produce, etc.) modulated optical local oscillator signal LO2′ by modulating optical local oscillator signal LO2 using intermediate frequency signal SIGIF while biased using a first setting of bias voltage WBIAS. The first setting of bias voltage WBIAS may configure EOM 56 to generate modulated optical local oscillator signal LO2′ using SSB-CS. Modulated optical local oscillator signal LO2′ may include wireless data DAT modulated onto its single upper sideband at frequency FLO2+FIF (or alternatively a single lower sideband at frequency FLO2−FIF).

At operation 146, optical combiner 52 may generate (output) optical signal OS' on optical path 40 by combining modulated optical local oscillator signal LO2′ with optical local oscillator signal LO1.

At operation 148, optical path 40 may illuminate photomixer 42 using optical signal OS′.

At operation 150, photomixer 42 may generate (e.g., produce, output, etc.) radio-frequency current (e.g., radio-frequency signal U(t)) on radiator(s) 36 based on optical signal OS' while biased using the first setting of bias voltage V_{BIAS} (e.g., a non-zero bias voltage).

At operation 152, radiator(s) 36 may radiate THF signals 32 at frequency FTHZ+FIF based on the radio-frequency current produced by photomixer 42 (e.g., a single wireless circuitry 35 may transmit THF signals 32 that include both the in-phase (I) and the quadrature-phase (Q) data of wireless data DAT). If there are updates to the transmit frequency of wireless circuitry 24 (e.g., as determined by software running on device 10 and/or a communication schedule or handover for device 10), processing may proceed to operation 156 via path 154.

At operation 156, IFTX chain 66 may tune intermediate frequency FIF of the intermediate frequency signals SIGIF provided to EOM 56 (e.g., by adjusting intermediate frequency local oscillator signal IFLO). This adjustment may occur while keeping LO light sources 70A/70B, optical local oscillator signals LO1/LO2, and frequencies FLO1/FLO2 fixed or constant. Processing may then loop back to operation 142 via path 158, but with an updated frequency FTHZ+FIF of the radiated THF signals 32 as given by the adjustment to intermediate frequency FIF produced by IFTX chain 66. Alternatively, path 158 may loop back to operation 140, between operations 140 and 142, or prior to operation 140. Since LO light sources 70A/70B, optical local oscillator signals LO1/LO2, and frequencies FLO1/FLO2 remain fixed or constant during tuning, OPLL 54 need not re-lock LO light sources 70A/70B. If there are no frequency updates, processing may proceed from operation 152 to operation 162 via path 160.

At operation 162, wireless circuitry 24 may switch to receive mode 132 (FIG. 7) while keeping LO light sources 70A/70B, optical local oscillator signals LO1/LO2, and frequencies FLO1/FLO2 fixed or constant. This prevents the need to re-lock LO light sources 70A/70B using OPLL 54 while minimizing phase noise and jitter.

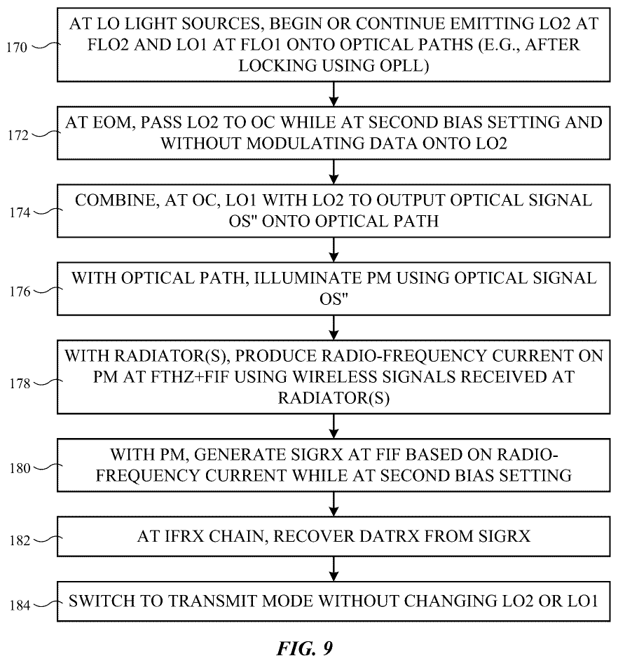

FIG. 9 is a flow chart of operations that may be performed by wireless circuitry 24 to receive THF signals 34 at frequency FTHZ+FIF while in receive mode 132 (e.g., the same frequency with which THF signals 32 were transmitted in transmit mode 130). At operation 170, LO light sources 70A and 70B may begin or continue emitting optical local oscillator signal LO2 at frequency FLO2 and optical local oscillator signal LO1 at frequency FLO1 onto optical paths 62 and 64 respectively.

At operation 172, EOM 56 may pass optical local oscillator signal LO2 to optical combiner 52 without modulating wireless data onto the optical local oscillator signal. EOM 56 may be at a second setting of bias voltage WBIAS or may still be at the first setting of bias voltage WBIAS.

At operation 174, optical combiner 52 may generate (output) optical signal OS″ on optical path 40 by combining optical local oscillator signal LO2 with optical local oscillator signal LO1.

At operation 176, optical path 40 may illuminate photomixer 42 using optical signal OS″.

At operation 178, radiator(s) 36 may produce radio-frequency current (e.g., radio-frequency signal U(t)) at photomixer 42 based on incident THF signals 34 at frequency FTHZ+FIF. Incident THF signals 34 may carry wireless data DATRX.

At operation 180, photomixer 42 may generate receive signal SIGRX at intermediate frequency FIF based on the radio-frequency current produced by radiator(s) 36 and optical signal OS″ while biased at a second setting of control signal V_{BIAS} (e.g., a bias voltage of zero).

At operation 182, IFRX chain 82 may recover, decode, and/or demodulate wireless data DATRX from receive signal SIGRX.

At operation 184, wireless circuitry 24 may switch to transmit mode 130 (FIG. 7) while keeping LO light sources 70A/70B, optical local oscillator signals LO1/LO2, and frequencies FLO1/FLO2 fixed or constant. If desired, wireless circuitry 24 may also tune intermediate frequency FIF and thus the frequency with which wireless circuitry 35 receives THF signals 34 (e.g., similar to operation 156 of FIG. 8). However, this adjustment has been omitted from FIG. 9 for the sake of clarity. Intermediate frequency FIF may also be adjusted in this way between signal transmission and reception or between signal reception and transmission.

In the example of FIG. 6, a single wireless circuitry 35 switches between transmitting and receiving THF signals using the same fixed frequencies FLO1 and FLO2 of optical local oscillator signals LO1 and LO2. If desired, wireless circuitry 24 may include a transmit wireless circuitry 35TX and a receive wireless circuitry 35RX that concurrently convey THF signals using the same fixed frequencies FLO1 and FLO2 of optical local oscillator signals LO1 and LO2 (e.g., using a full-duplex scheme).

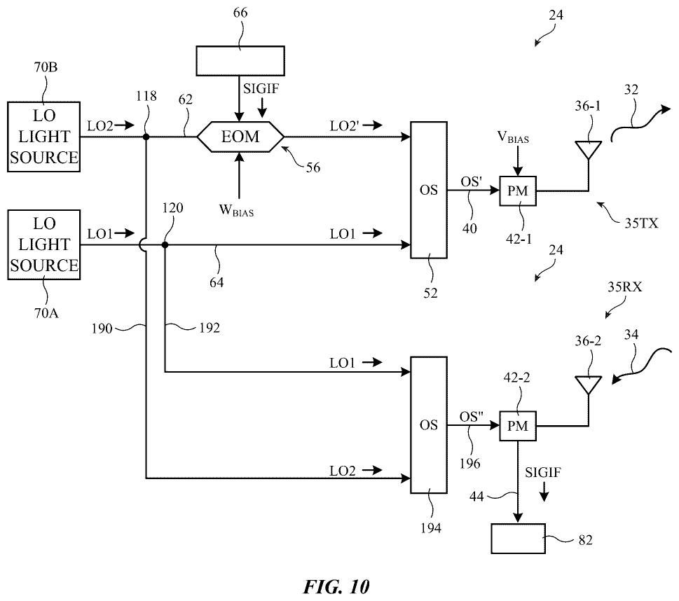

FIG. 10 is a circuit diagram showing one example of how wireless circuitry 24 may implement a full-duplex architecture. As shown in FIG. 10, wireless circuitry 24 may include a transmit wireless circuitry 35TX and a receive wireless circuitry 35RX. Transmit wireless circuitry 35TX may include a photomixer 42-1 coupled to radiator(s) 36-1. Receive wireless circuitry 35RX may include a photomixer 42-2 coupled to radiator(s) 36-2.

Wireless circuitry 24 may include an optical path 190 coupled to node 118 on optical path 62, an optical path 192 coupled to node 120 on optical path 64, and an additional optical combiner 194. OPLL 54 (FIG. 6) has been omitted from FIG. 10 for the sake of clarity. Optical path 192 may couple node 120 to optical combiner 194. Optical path 190 may couple node 118 to optical combiner 194. An optical path 196 may optically couple the output of optical combiner 194 to photomixer 42-2. Photomixer 42-2 may be coupled to IFRX chain 82 over signal path 44.

Wireless circuitry 24 of FIG. 10 may transmit THF signals 32 using transmit wireless circuitry 35TX and may concurrently receive THF signals 34 using receive wireless circuitry 35RX. Wireless circuitry 24 may use the same optical local oscillator signals LO1 and LO2 to both transmit THF signals 32 and receive THF signals 34.

Optical path 62 may convey optical local oscillator signal LO2 to EOM 56. Optical path 190 may convey optical local oscillator signal LO2 from optical path 62 (node 118) to optical combiner 194. Optical path 64 may convey optical local oscillator signal LO1 to optical combiner 52. Optical path 192 may convey optical local oscillator signal LO1 from optical path 64 (node 120) to optical combiner 194.

EOM 56 may generate modulated optical local oscillator signal LO2′ by modulating optical local oscillator signal LO2 with intermediate frequency signal SIGIF from IFTX chain 66. Optical coupler 52 may generate optical signal OS' on optical path 40 by combining optical local oscillator signal LO1 with modulated optical local oscillator signal LO2′. Optical coupler 194 may generate optical signal OS″ on optical path 196 by combining optical local oscillator signal LO1 with optical local oscillator signal LO2.

Optical path 40 may illuminate photomixer 42-1 using optical signal OS' while optical path 196 concurrently illuminates photomixer 42-2 using optical signal OS″. Photomixer 42-1 may generate THF signals 32 that are radiated by radiator(s) 36-1 at frequency FTHZ+FIF based on optical signal OS' while biased using the first bias setting for control signal V_{BIAS}. Photomixer 42-2 may concurrently generate receive signal SIGRX at intermediate frequency FIF on signal path 44 based on optical signal OS″ and THF signals 34 at frequency FTHZ+FIF that are incident upon radiator(s) 36-2, while biased using the second bias setting for control signal V_{BIAS} (e.g., a bias voltage of zero). IFRX chain 82 may extract wireless data DATRX from receive signal SIGRX.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Wireless circuitry comprising:
an antenna element;
a photomixer coupled to the antenna element;
an optical signal path configured to illuminate the photomixer using a first optical local oscillator (LO) signal at a first frequency and a second optical LO signal at a second frequency that is different from the first frequency, the antenna element being configured to convey a first radio-frequency signal at a third frequency based on the first optical LO signal and the second optical LO signal; and
an electro-optical modulator (EOM) disposed on the optical signal path, the EOM being configured to modulate the second optical LO signal using a second radio-frequency signal at a fourth frequency that is lower than the third frequency.

2. The wireless circuitry of claim 1, further comprising:
a signal path coupled to the photomixer, wherein the photomixer is configured to generate, based on the first optical LO signal at the first frequency, the second optical LO signal at the second frequency, and a third radio-frequency signal incident on the antenna element at the third frequency, a receive signal at the fourth frequency on the receive path.

3. The wireless circuitry of claim 2, further comprising:
a receive chain coupled to the signal path and configured to demodulate wireless data from the receive signal.

4. The wireless circuitry of claim 3, wherein the antenna element is configured to transmit the first radio-frequency signal, the photomixer is biased using a bias voltage, the bias voltage has a non-zero magnitude while the antenna element transmits the first radio-frequency signal, and the bias voltage has a magnitude less than the non-zero magnitude while the photomixer generates the receive signal.

5. The wireless circuitry of claim 1, further comprising:
a mixer communicatively coupled to an electrode on the EOM, the mixer being configured to generate the second radio-frequency signal by modulating wireless data onto a radio-frequency LO signal.

6. The wireless circuitry of claim 1, wherein the EOM is configured to perform single sideband carrier suppression on the second optical local oscillator signal.

7. The wireless circuitry of claim 6, wherein the second frequency is separated from the first frequency by a frequency offset, the third frequency being equal to the frequency offset plus the fourth frequency.

8. The wireless circuitry of claim 6, wherein the second frequency is separated from the first frequency by a frequency offset, the third frequency being equal to the frequency offset minus the fourth frequency.

9. The wireless circuitry of claim 1, further comprising:
a transmit chain communicatively coupled to an electrode on the EOM and configured to generate the second radio-frequency signal, the transmit chain being configured to tune the third frequency of the first radio-frequency signal by adjusting the fourth frequency of the second radio-frequency signal.

10. The wireless circuitry of claim 1, wherein the optical signal path includes a first optical path, a second optical path, and a first optical combiner that couples the first optical path and the second optical path to the photomixer, the EOM being disposed on the second optical path, and the wireless circuitry further comprising:
a first light source configured to emit the first optical LO signal onto the first optical path; and
a second light source configured to emit the second optical LO signal onto the second optical path.

11. The wireless circuitry of claim 10, further comprising:
an additional antenna element coupled to an additional photomixer, wherein
the antenna element is configured to transmit the first radio-frequency signal,
the optical signal path further includes a third optical path coupled to a node on the first optical path, a fourth optical path coupled to a node on the second optical path, and a second optical combiner that couples the third optical path and the fourth optical path to the additional photomixer, and
the additional antenna element is configured to receive a third radio-frequency signal at the third frequency based on the first optical LO signal at the first frequency and the second optical LO signal at the second frequency.

12. A method of operating wireless circuitry, the method comprising:
emitting, using a first light source, a first optical local oscillator (LO) signal at a first frequency onto a first optical path;
emitting, using a second light source, a second optical LO signal at a second frequency different from the first frequency onto a second optical path;
modulating, using an electro-optical modulator (EOM) disposed on the second optical path, wireless data onto a first sideband of the second optical LO signal while suppressing a second sideband of the second optical LO signal;
illuminating a photomixer using the first optical LO signal and the first sideband of the second optical LO signal;
generating, using the photomixer, a first current on a radiator based on the first optical LO signal and the first sideband of the second optical LO signal; and
transmitting, using the radiator, a first radio-frequency signal associated with the first current.

13. The method of claim 12, wherein the EOM modulates the wireless data onto the first sideband during a first time period, the first radio-frequency signal is at a third frequency different from the first frequency and the second frequency, and the method further comprises:
generating, using the photomixer during a second time period different from the first time period, a second current on a signal path based on the first optical LO signal, the second optical LO signal, and a second radio-frequency signal incident upon the radiator at the third frequency.

14. The method of claim 13, further comprising:
applying a bias voltage to the photomixer during the first time period; and
decoupling the bias voltage from the photomixer during the second time period.

15. The method of claim 13, wherein the first light source keeps the first frequency constant between the first and second time periods and the second light source keeps the second frequency constant between the first and second time periods.

16. The method of claim 12, further comprising:
transmitting, using a transmit chain, a second radio-frequency signal that includes the wireless data to an electrode of the EOM.

17. The method of claim 16, wherein the second frequency is separated from the first frequency by a frequency offset, the second radio-frequency signal is at a third frequency, and the first radio-frequency signal is at a fourth frequency given by the third frequency plus the frequency offset.

18. An electronic device comprising:
a photomixer;
a radiator coupled to the photomixer;
a first light source configured to generate a first optical local oscillator (LO) signal at a first frequency;
a second light source configured to generate a second optical LO signal at a second frequency different from the first frequency;
an optical signal path coupled to the first light source and the second light source and configured to illuminate the photomixer using the first optical LO signal and the second optical LO signal; and
an electro-optical modulator (EOM) disposed on the optical signal path, wherein
the EOM is configured to suppress a single sideband of the second optical LO signal, and
the photomixer is configured to transmit, using the radiator, a radio-frequency signal based on the first optical LO signal and the second optical LO signal.

19. The electronic device of claim 18, wherein the photomixer comprises a programmable heterodyne photodiode.

20. The electronic device of claim 18, further comprising:
a phased antenna array that includes the radiator; and
an optical phase shifter disposed on the optical signal path and configured to apply an optical phase shift to the first optical LO signal.
